(19) United States
(12) Patent Application Publication
(10) Pub. No.: US 2007/0063585 A1
(43) Pub. Date: Mar. 22, 2007

(54) TRACTION BAND FOR USE WITH A SNOWMOBILE

(76) Inventors: Andre Deland, Drummondville (CA); Yves St-Pierre, Wickham (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 11/531,881

(22) Filed: Sep. 14, 2006

(30) Foreign Application Priority Data
Sep. 15, 2005 (CA) 2,519,857

(51) Int. Cl. B62D 55/24

(52) U.S. Cl. 305/178; 305/179; 305/165

(57) ABSTRACT

This invention relates to a traction band for use with a snowmobile or the like and more particularly, to a traction band of reduced weight but as efficient as a regular traction band. The improved traction band comprises a longitudinal flexible body having a width defined by two side surfaces, and a series of reinforcing rods which do not extend across the full width. The rods are embedded within the body in an alternating fashion from one of the side surfaces with predetermined intervals in the longitudinal direction of the same.

### FIELD OF THE INVENTION

The present invention relates to a traction band for use with a snowmobile and more particularly to a traction band of reduced weight.

### BACKGROUND OF THE INVENTION

Different conventional track driven vehicles were developed many years ago and are well known to everybody. A traction band is the principal part in these vehicles. An output from an engine is transmitted to the traction band and then is transmitted to a driving surface by this band to provide necessary running performance for the track driven vehicle.

The prior art teaches to the man skilled in the art that a plurality of reinforcing members, like metallic or plastic rods, are usually embedded within a body of the traction band for its reinforcing. These reinforcing members are spaced apart from each other and transverse the body from its one side surface to the other. (See U.S. Pat. No. 3,917,360 (Gregoire), U.S. Pat. No. 4,270,811 (Trautwein) and U.S. Pat. No. 5,709,440 (Lecours)).

These systems have good load supporting characteristics, but the traction band is unnecessarily weighty, and to impel such traction band an additional energy is required.

Thus, there is a need to develop a traction band of reduced weight but as efficient as common track belts.

### OBJECTS OF THE INVENTION

Accordingly, an object of the present invention is to provide an improved traction band that obviates the above-mentioned disadvantages.

One more object of the present invention is to provide an improved traction band of reduced weight.

A further object of the present invention is to provide an improved traction band which is easy to manufacture.

Another object of the present invention is to provide an improved traction band which is inexpensive.

Other and further objects and advantages of the present invention will be obvious upon an understanding of the illustrative embodiments about to be described or will be indicated in the appended claims, and various advantages not referred to herein will occur to one skilled in the art upon employment of the invention in practice.

### SUMMARY OF THE INVENTION

To attain these and other objects which will become more apparent as the description proceeds according to one aspect of the present invention there is provided a traction band for use with a snowmobile. The traction band comprises a longitudinal flexible body having a width defined by two side surfaces, and a series of reinforcing rods embedded within the body in an alternating fashion from one of the side surface with predetermined intervals in the longitudinal direction of the same.

The length of reinforcing rods of the traction band preferably is depended on the width of the body according to the relation: B>L>Co×B, wherein B represents the width of said body, L represents the length of the reinforcing rod, and Co is a coefficient. The coefficient is preferably chosen between 0.5 and 0.9.

According to another aspect of the present invention, at least one of the reinforcing rods has a length different from any others.

All this modifications allowed to reduce the weight of the traction band.

The invention accordingly comprises the furthers of construction, combination of elements, and arrangement of parts which will be exemplified in the construction hereinafter set forth, and the scope of the invention will be indicated in the claims.

### BRIEF DESCRIPTION OF THE DRAWINGS

For a fuller understanding of the nature and object of the invention, reference should be had to the following detailed description taken in connection with the accompanying drawings in which:

FIG. 1 is a side view of a snowmobile;

FIG. 2 is a view of the traction band of the first embodiment; and

FIG. 3 is a view of the traction band of the second embodiment.

### DETAILED DESCRIPTION OF THE PREFERRED EMBODIMENTS

With reference to the annexed drawings, the preferred embodiments of the present invention will be herein described for indicative purposes and by no means as of limitation.

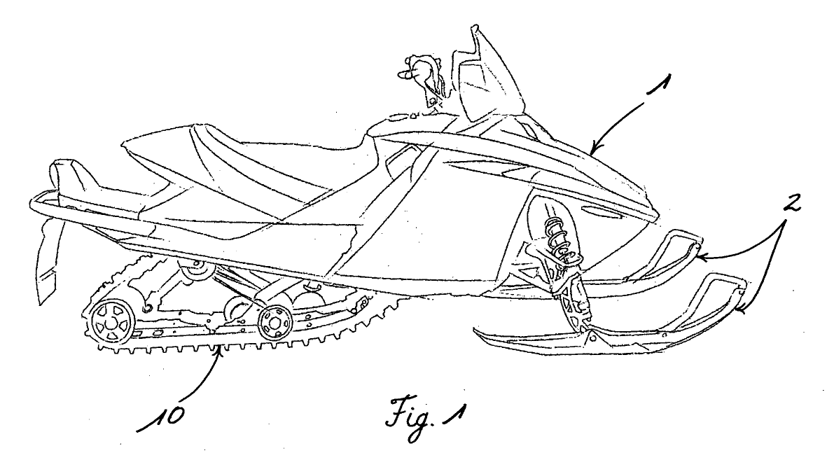

FIG. 1 shows as example a traditional snowmobile 1 supported at its forward end on a pair of steerable skis 2 and its rearward end on a traction band 10 which in known manner is configured as an endless body having a conventional outer surface for contacting with ground and inner surface for engagement with a driving system (not shown). Different crawler-type vehicles, tractors or equipment having tracks for providing both ground support and tractive ability might be represented as well. The new traction band 10 may be helpful for them too.

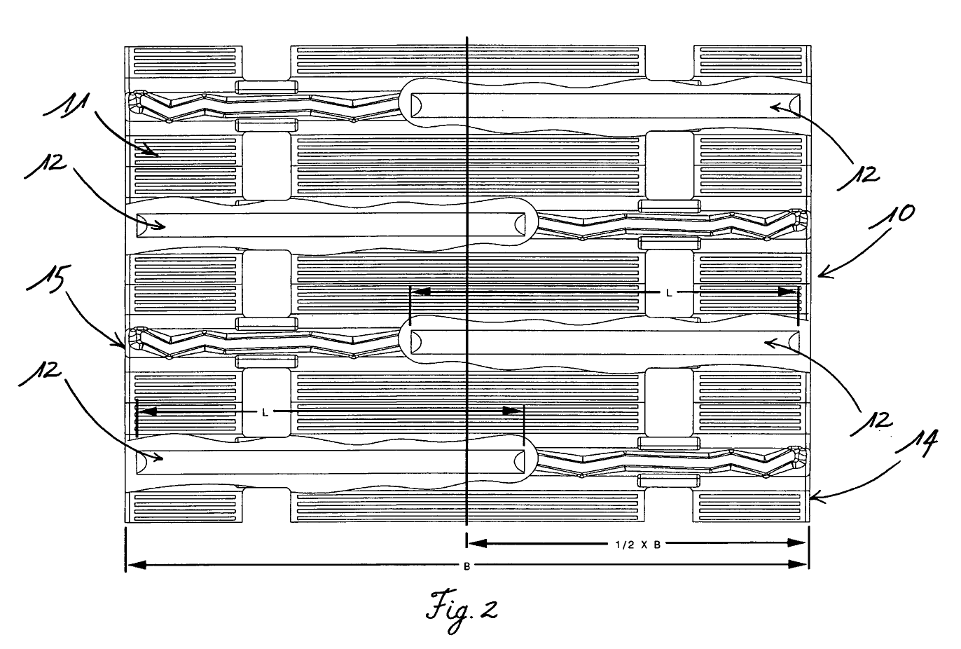

Referring to FIG. 2, the traction band 10 comprises a longitudinal flexible body 11 having a width B defined by two side surfaces 14 and 15. A series of reinforcing rods 12 that are shorter than the width B are embedded within the body 11 in an alternating fashion from one of the side surfaces 14 or 15. The reinforcing rod 12 is embedded into the body 11 with predetermined intervals in the longitudinal direction of this body 11.

As is well understood, these reinforcing rods may assume a variety of forms.

The length L of reinforcing rods 12 is dependent of the width B of the body 11 according to the relation: B>L>Co×B, wherein B represents the width of said body, L represents the length of the reinforcing rod, and Co is a coefficient preferably chosen between 0.5 and 0.9.

It is also possible that the length of the rods vary from one and other.

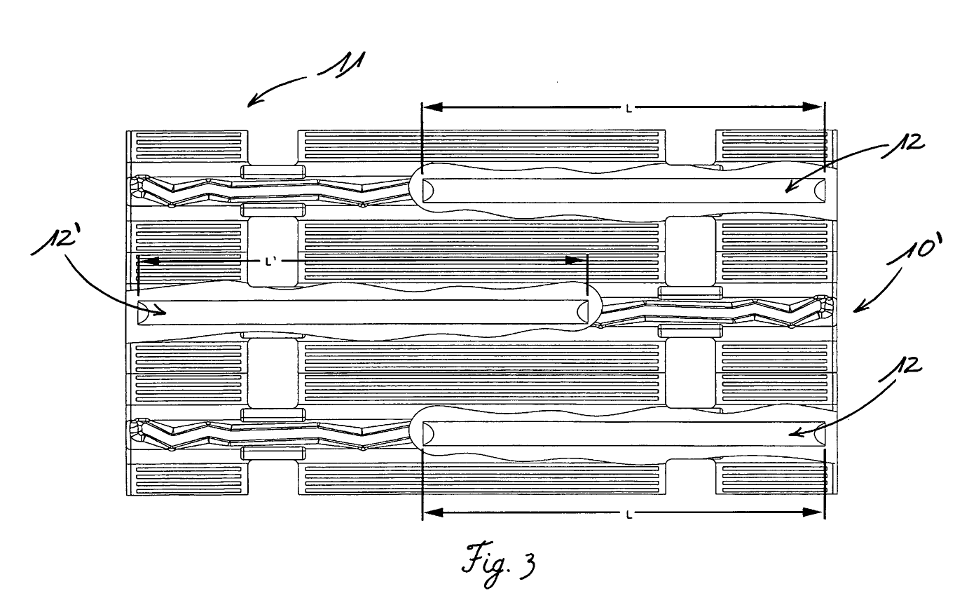

For example, in a second embodiment shown in FIG. 3, a traction band 10′ includes at least one of the reinforcing rods 12′ which has a length L′ different from the length L of the others rods 12 (L′≠L).

The reinforcing rods 12 and 12′ are made from any suitable material well known in the art.

Using the reinforcing rods according to the present invention allows to reduce weight of the traction band 10 with the same efficiency as a regular traction band.

The drawings and the description attached to it are only intended to illustrate the idea of the invention. As to the details, the invention may vary within the scope of the claims. So, the shape reinforcing rods may be formed as desired, considering the needs and specific snowmobile models.

Although the present traction band has been described with a certain degree of particularity, it is to be understood that the disclosure has been made by way of example only and that the present invention is not limited to the features of the embodiment(s) described and illustrated herein, but includes all variations and modifications within the scope and spirit of the invention as hereinafter claimed.

1. A traction band for use with a snowmobile or the like, comprising:
a longitudinal flexible body having a width defined by two side surfaces; and
a series of reinforcing rods embedded within said body in an alternating fashion from one of said side surfaces with predetermined intervals in the longitudinal direction of the same.
wherein the length of said rods is less than said width.

2. The traction band according to claim 1, wherein a length of said reinforcing rods depends upon said width of the body according to the relation:
B>L>Co×B
wherein B represents the width of said body;
wherein L represents the length of said reinforcing rod;
and Co is a coefficient that is between 0.5 and 0.9.

3. The traction band according to claim 2, wherein at least one of said reinforcing rods has a length different from any other.

4. The traction band according to claim 2 wherein the length of the rods vary.
